(19) United States
(12) Patent Application Publication
(10) Pub. No.: US 2007/0064681 A1
(43) Pub. Date: Mar. 22, 2007

(54) Method and system for monitoring a data channel for discontinuous transmission activity

(75) Inventors: Marc A. Boillot, Plantation, FL (US); Pratik V. Desai, Boca Raton, FL (US); Md S. Islam, Cooper City, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/233,337

(22) Filed: Sep. 22, 2005

(51) Int. Cl. H04L 12/66

(52) U.S. Cl. 370/352

(57) ABSTRACT

A system (100) and method (400) for monitoring a data channel for discontinuous transmission activity can include a monitoring unit (210), in which the monitoring unit can identify a source of modifying the discontinuous transmission activity based on receipt of an identifier packet, and an equalizer (214) coupled to the monitoring unit. When the monitoring unit determines that an identifier packet has been modified by a source over a communication channel, the equalizer can apply a compensatory equalization associated with the identified source to compensate for equalization applied at the source.

### FIELD OF THE INVENTION

The embodiments herein relates generally to methods and systems that transmit and receive communication data and more particularly, that operate using discontinuous transmission activity to conserve battery power.

### DESCRIPTION OF THE RELATED ART

The use of portable electronic devices has increased in recent years. Cellular telephones, in particular, have become commonplace with the public. Many of these devices require a battery for portability purposes which provides a limited supply of power. The devices commonly employ a vocoder to reduce the system bandwidth and conserve power during voice communication. The vocoder is a device which converts analog speech waveforms into digital signals. The digital signals are then typically transmitted to other portable electronic devices where they are decoded and played out of a speaker to a user at the receiving portable device.

The vocoder generally includes a voice activity detector to determine when speech is present and when speech is not present. When speech is present, the vocoder employs sophisticated signal processing routines to compress the data prior to transmission. When the voice activity detector determines a lack of speech present, the vocoder inserts comfort noise frames to serve as background noise frames. The vocoder generates comfort noise frames which signify that the vocoder is operating in discontinuous transmission mode (DTX). During DTX, the vocoder transmits fewer frames with the comfort noise frames spaced over longer time intervals.

The communication device transmits data frames including comfort noise frames processed by the vocoder to other communication devices. The data generally passes through multiple communication base stations or base receivers before reaching the intended recipient. A base station generally opens a communication channel with a sending unit, establishes a communication link with a receiving unit, processes the data, and sends the data to the receiving unit across the established communication link. The base station may decode the data, apply its own form of audio equalization, and re-encode the data to account for equalization effects across the communication channel. The communication device that receives the data is unaware that the base station or receiver has processed the audio signal. The communication device that sent the data is also not aware of any post processing applied to the data during the communication process. The resulting speech decoded by the vocoder of the receiving communication device may be of a different sound nature than that of the original speech that was encoded by the vocoder of the sending communication device due to the intermediate processing at the base station or receiver. In this instance, the communication devices are unable to accurately represent the original speech nature because they do not have knowledge of the processing effects incurred during communication. In other words, the processing performed on a communication channel is based on an assumed environment and not reflective of an actual environment.

### SUMMARY

The method and system concerns a method for monitoring a data channel for discontinuous transmission activity. The method includes the steps of identifying a source of modification of the discontinuous transmission activity based on receipt of an identifier packet, and applying an equalization based on the source identified in view of the identifier packet. The method can also include the step of modifying the identifier packet during discontinuous transmission activity over a communication channel. The method can also include the step of preserving the identifier packet over the communication channel. As an example, a source can modify the identifier packet over a communication network, where the source of modification of the discontinuous transmission activity can be a mobile communication device or a transcoder.

The method can further include the steps of generating an audio signal from data received on the data channel, and applying the equalization to the audio signal in view of the identifier packet. The method can additionally include marking an identifier packet within a first communication device during discontinuous transmission activity, and transmitting the identifier packet over a communication channel to a second communication device. As an example, the identifier packet can be modified over a communication channel during discontinuous transmission activity, where the modification associates the identifier packet with the source. Accordingly, the equalization can further include compensating for an audio equalization applied at the source.

The method can also include the steps of counting a number of consecutive audio frames received, and generating a comfort noise update when a pre-specified number of consecutive audio frames are counted. As an example, the pre-specified number can be at least a minimum number of audio frames representative of a voice utterance.

The present method and system also concerns a system for monitoring a data channel for discontinuous transmission activity. The system can include a monitoring unit, in which the monitoring unit can identify a source of the discontinuous transmission activity based on receipt of an identifier packet, and an equalizer coupled to the monitoring unit. When the monitoring unit determines that the identifier packet has been modified by the source over a communication channel, the equalizer can apply a compensatory equalization associated with the identified source to compensate for equalization applied at the source. The system can also include suitable software and/or circuitry to carry out the processes described above.

The system can also include a processor communicatively coupled to the monitoring unit to modify the identifier packet over a communication channel during discontinuous transmission activity. As an example the identifier packet can be modified to be one of an audio frame type, a silence frame type, a null frame type, or an invalid frame type. The identifier packet can be modified prior to being received by the monitoring unit, where the modification associates the identifier packet with the source. The processor can reside within a mobile communication device or a base receiver for modifying the identifier packet.

The system can further include a marker unit communicatively coupled to the monitoring unit to create an identifier packet in a first communication device, where the identifier packet can be modified within a communication network during discontinuous transmission activity, and the identifier packet can be received by a second communication device, where the second communication device can include the monitoring unit and the equalizer.

The system can also include an audio module connected to the equalizer that can receive data from the data channel and can generate an audio signal from the data received, and where the equalizer can apply compensatory equalization to the audio signal in view of the identifier packet to compensate for equalization applied to the audio signal at the source. The system can additionally include a logic unit coupled to the monitoring unit that can count a number of consecutive audio frames received from the data channel, and a controller connected to the logic unit that can update comfort noise generated by an audio module when a pre-specified number of consecutive audio frames are counted by the logic unit, when the comfort noise is differentially encoded from the last audio frame received.

As an example, the controller can disable comfort noise generation when the pre-specified number of consecutive audio frames represents a voice utterance length shorter than the minimal voice length a human can vocalize. As another example, the controller can enable comfort noise generation when the pre-specified number of consecutive audio frames is of a length at least representative of a voice utterance length a human can vocalize.

In another embodiment, a system for monitoring a data channel for discontinuous transmission activity based on receipt of an identifier packet can include a marker unit that can mark an identifier packet within a data stream during discontinuous transmission activity, where the identifier packet can be transmitted from a first communication device to a second communication device over a communication channel, and a monitoring unit communicatively coupled to the marker unit that can identify a source that modified the identifier packet over the communication channel during discontinuous transmission activity. The system can further include an audio module cooperatively connected to the monitoring unit that can generate an audio signal from the data stream received over the communication channel, and an equalizer coupled to the monitoring unit, where the equalizer can apply a compensatory equalization to the audio signal to account for equalization applied at the source.

### BRIEF DESCRIPTION OF THE DRAWINGS

The features of the system, which are believed to be novel, are set forth with particularity in the appended claims. The embodiments herein, can be understood by reference to the following description, taken in conjunction with the accompanying drawings, in the several figures of which like reference numerals identify like elements, and in which:

FIG. 1 illustrates a communication system in accordance with an embodiment of the inventive arrangements;

FIG. 2 illustrates the communication system of FIG. 1 in greater detail in accordance with an embodiment of the inventive arrangements;

FIG. 3 illustrates a block diagram of a system for monitoring a data channel for discontinuous transmission activity in accordance with an embodiment of the inventive arrangements;

FIG. 4 illustrates a method for monitoring a data channel for discontinuous transmission activity in accordance with an embodiment of the inventive arrangements;

FIG. 5 illustrates a method for controlling discontinuous transmission activity in accordance with an embodiment of the inventive arrangements;

FIG. 6 illustrates a flowchart for controlling discontinuous transmission activity in accordance with an embodiment of the inventive arrangements; and

FIG. 7 is a pictorial presenting frame slot transmissions during discontinuous transmission activity in accordance with an embodiment of the inventive arrangements.

FIG. 8 illustrates frame slot transmissions for a base receiver in tandem mode in accordance with an embodiment of the inventive arrangements

FIG. 9 illustrates frame slot transmissions for a base receiver in pass through mode in accordance with an embodiment of the inventive arrangements

### DETAILED DESCRIPTION

While the specification concludes with claims defining the features of the embodiments of the invention that are regarded as novel, it is believed that the method and system will be better understood from a consideration of the following description in conjunction with the drawing figures, in which like reference numerals are carried forward.

As required, detailed embodiments of the present method and system are disclosed herein; however, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

The embodiment presents a system and method for monitoring a data channel for discontinuous transmission activity. For example, a transmitting unit can initiate discontinuous transmission activity and transmit communication data during the discontinuous transmission activity to a receiving unit. The receiving unit can identify a source of modification of the discontinuous transmission activity based on receipt of an identifier packet and apply an equalization based on the source identified in view of the identifier packet. This equalization can be tailored to compensate for an audio equalization applied at the source when the source is accordingly identified.

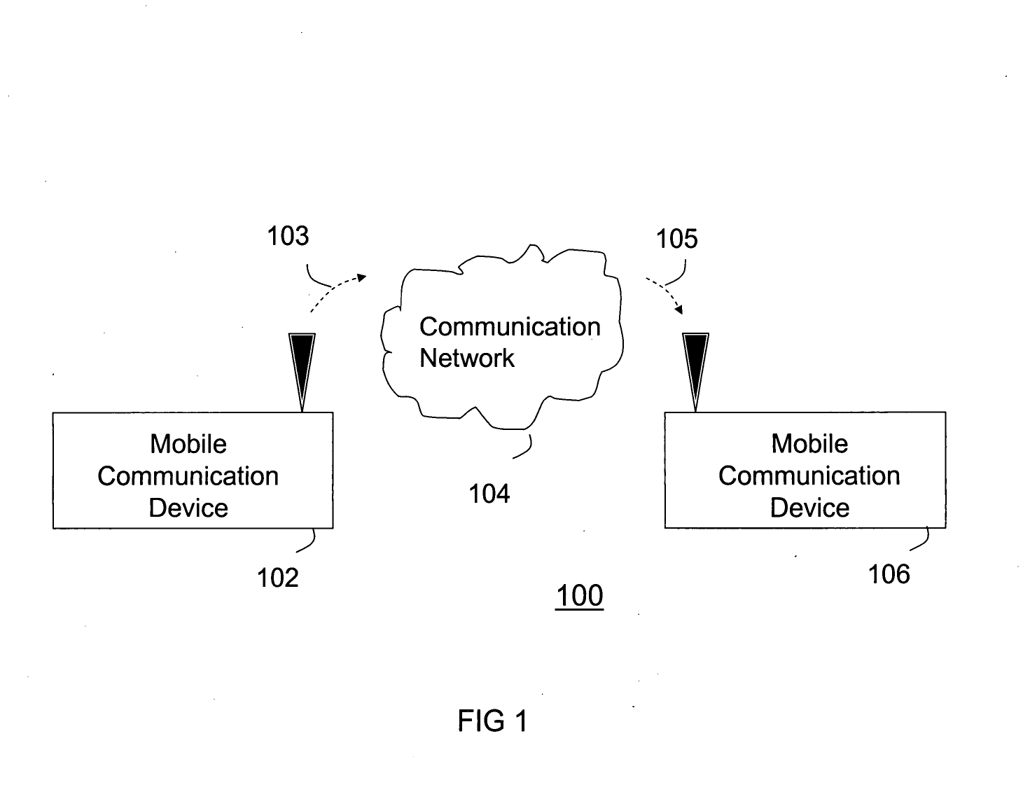

Referring to FIG. 1, a communication system 100 is shown. The communication system 100 can include a transmitting unit 102 as a first communication device and a receiving unit 106 as a second communication device. In one arrangement, the transmitting unit 102 can transmit communication data, such as a voice signal, to the receiving unit 106 over a communication network 104. As an example, the transmitting unit 102 and the receiving unit 106 can communicate with one another through the communication network 104 using wireless communication links 103 and 105. It is to be understood that the transmitting unit 102 and receiving unit 106 can communicate with one another over hard-wired connections, as well.

In one arrangement, the transmitting unit 102 can communicate voice data over the communication network 104 to the receiving unit 106. For example, during a voice call, the transmitting unit 102 can transmit voice data representing both voice and silence information such as comfort noise to the receiving unit 106.

It should also be noted that the transmitting unit 102 is not limited to transmitting signals and that the receiving unit 106 is not limited to receiving signals. These terms are merely meant to distinguish the transmitting unit 102 from the receiving unit 106. As such, the transmitting unit 102 can receive any suitable type of communication signals. Similarly, the receiving unit 106 can transmit any suitable type of communication signals. As an example the transmitting unit 102 and receiving unit 106 can mobile communication units, such as cellular telephones, personal digital assistants, two-way radios, etc. Of course, the transmitting unit 102 can be any electronic device that is capable of at least encoding data, and the receiving unit can be any electronic device that is capable of at least decoding data.

The transmitting unit 102 and the receiving unit 106 can also be referred to as portable computing devices, both of which can be loaded with a computer program having a plurality of code sections. These code sections can be executable by the portable computing devices (102, 106) for causing the portable computing devices (102, 106) to perform the inventive methods that will be described below.

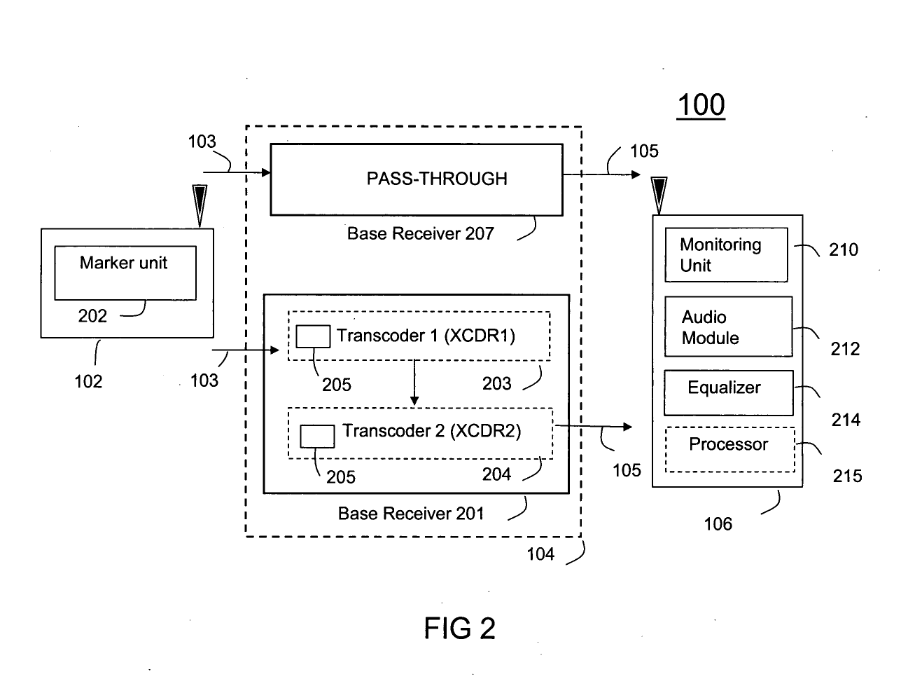

Referring to FIG. 2, a more detailed block diagram of the communication system 100 is shown. In one arrangement, the communication network 104 can include a base receiver 201 to allow voice communication over the communication links 103 and 105. The base receiver 201, can set up a voice call or break down a voice call between the transmitting unit 102 and the receiving unit 106. Additionally, the base receiver 201, can process packets of data received within the communication network 104, or it can forward the packets of data without processing the data. For example, the base receiver 201 can receive data packets from the transmitting unit 102 and send them to the receiving unit 106 without any intermediate processing. The data packets can pass through the base receiver 201 without modification via the base receiver 207. In another example, the base receiver 201 can include a first transcoder 203 and a second transcoder 204. As is known in the art, the transcoder 203 and 204 can include a decoder 205, a processor, and an encoder. The processor 205 can apply equalization. For example, the decoder can decode data received by the transcoder 203, the processor can process and equalize the decoded data, and the encoder can encode the data that can be sent from the transcoder 203 and then transmitted by the base receiver 201. The base receiver 201 can also receive a data packet which can then be further processed by the first transcoder 203 and the second transcoder 204. In this arrangement, the transcoders 203 and 204 perform a serial vocoding operation known in the art as tandem vocoding.

In one arrangement, the base receiver 201 can process data when the data packet is in a format not common to both the transmitting unit 102 and the receiving unit 106. For example, the base receiver 201 can interpret descriptive information within the data packet such as the type of vocoder used to compress the data. Based on the descriptive information, the base receiver 201 can process and render the data through a transcoding operation into a format that is acceptable to both the transmitting unit 102 and the receiving unit 106. The base receiver 207 can forward the data packets without processing in a pass-through mode if the transmitting unit 102 and the receiving unit 106 each utilize the same type of vocoder. Also, the data packets can be processed in tandem by both the first transcoder 203 and the second transcoder 204 if separate vocoders in the transmitter 102 and receiver 106 are employed.

Referring again to FIG. 2, the transmitting unit 102 can include a marker unit 202 that can mark data to identify the data packet as specific type of data packet prior to being transmitted over the communication network 104. In one arrangement, the marker unit 202 can change the header of a data packet during discontinuous transmission activity to create an identifier packet. For example, the header can describe the type of data packet as a voice or a silence packet, though there are many other frame types. Briefly, the marker unit 202 can retrieve a data packet produced by a vocoder within the transmitting unit 102 and it can overwrite the header to create an identifier packet with a specific header type recognizable by the same vocoder.

In one arrangement, the receiving unit 106 can include a monitoring unit 210, an audio module 212, an equalizer 214, and an optional processor 215. The monitoring unit 210 can be coupled to the audio module 212, which can be coupled to the equalizer 214. Briefly, the monitoring unit 210, can monitor a data channel for discontinuous transmission activity (DTX). Discontinuous transmission activity can occur when the transmitting unit 102 determines that a user is not speaking into the mobile communication device. The transmitting unit 102 can identify periods of silence between speech and elect to send comfort noise data in place of voice data. The comfort noise data can be transmitted less frequently than voice data to conserve battery power. During DTX, the transmitting unit 102 can send data packets with header information that identifies the data packet as one of audio or comfort noise, for instance. The audio module 212, can generate an audio signal from the received data and can produce speech for audio data and silence for comfort noise data. The equalizer can be communicatively coupled to the monitoring unit 210 and apply an equalization to the audio signal as directed by the monitoring unit 210.

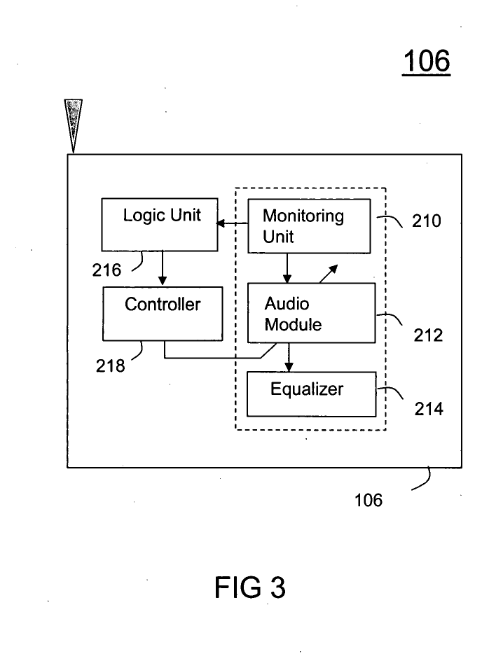

Referring to FIG. 3, an extended arrangement of the receiver unit 102 for monitoring a data channel for discontinuous transmission activity is shown. In this arrangement, the receiving unit 106 can additionally include a logic unit 216 coupled to the monitoring unit 210, and a controller 218 coupled to the audio module 212. The controller 218 can receive input from the logic unit 210 to control comfort noise generation at the audio module 212. Additionally, the monitoring unit 210 can be directly coupled to the audio module 212 which can be directly coupled to the equalizer 212. The monitoring unit 210 can receive data packets over the communication link 105 and monitor the received data for occurrences of an identifier packet. Briefly, the logic unit 216 can count a number of consecutive audio frames received by the monitoring unit 210 from the data channel. The controller 218 can generate a comfort noise update within the audio module 212 when a pre-specified number of consecutive audio frames are counted by the logic unit 216.

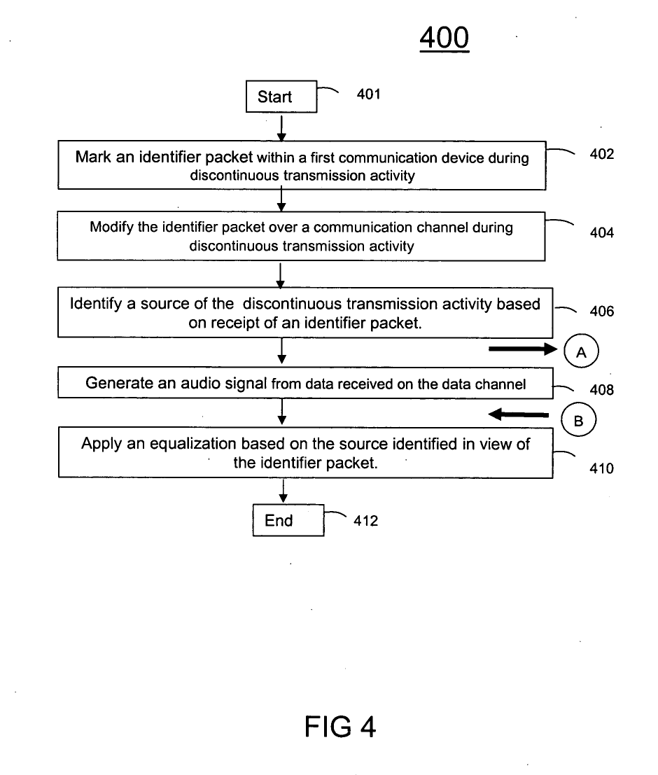

Referring to FIG. 4, a method 400 will be used to explain an example for monitoring a data channel for discontinuous voice activity. To describe the method 400, reference will be made to FIG. 2, although it is understood that the method 400 can be implemented in any other suitable device or system using other suitable components. Moreover, the method is not limited to the order in which the steps are listed in the method 400. In addition, the method 400 can contain a greater or a fewer number of steps than those shown in FIG. 4.

At step 401, the method 400 can start. At step 402, an identifier packet within a first communication device can be marked during discontinuous transmission activity. One way to mark an identifier packet is to change the descriptive header of a data packet to another header type.

For example, referring to FIG. 2. the marking unit 202 can change the header of a data packet generated during DTX to an invalid frame type (I) which consists of a frame header describing the frame as invalid followed by random data.

At step 404, the identifier packet can be modified over a communication channel during discontinuous transmission activity. For example, referring to FIG. 2, the marker unit 202 can create an identifier packet that can change if the packet is processed by the transcoders 203 and 204 of the base receiver 201. Accordingly, the base receiver 201 can modify the identifier packet when the data is processed in a tandem operation. The invalid frame type can be selected as the identifier packet with special interpretation within transcoder 203. Those skilled in the art can appreciate that there are a number of transcoders, each supporting one or a multitude vocoders as a processor, each with its own specific set of frame types. The transcoder 203 can interpret the invalid frame as an exception frame during DTX for comfort noise generation. The exception frame (invalid frame) can be recognized by the base receiver 201 and can also be recognized by the receiving unit 106 as a cue to generate silence though not changed by the base receiver 201. The base receiver 201 can pass the invalid frames to the transcoder 203 which can replace the invalid frames with a CNU frame.

It is also possible that the base receivers 201 or 207 will not pass the data packets to the first transcoder 203 when it recognizes the vocoder data format as one common to the transmitting unit 102 and the receiving unit 106. In this condition, the base receiver 201 or 207, can forward the packets through without further processing by the transcoders 203 or 204, except for the replacement of empty frame slots with null frames, which is considered a pass-through mode.

At step 406, a source of modification of the discontinuous transmission activity based on receipt of an identifier packet can be identified over the communication channel. Referring to FIG. 2, the monitoring unit 210 can check for an invalid type within the data received by the receiving unit 106. The monitoring unit 210 can identify the base receiver 201 as the source of discontinuous transmission activity if an invalid frame is not received. The monitoring unit 210 identifies the transmitting unit 102 as the source of discontinuous transmission activity if an invalid frame is received.

At step 408, an audio signal from data received on the communication channel can be generated. For example, referring to FIG. 2, the audio module 212 can receive data packets from the receiving unit 106, and can decode the data packets and convert them to an audio signal that represents sections of both speech and silence. The receiving unit 106 can receive audio frame types, silence frame types, null frame types, and invalid frame types. The receiving unit 106 can produce an audio signal that can be played out a speaker or headset on the receiving unit 106 to the user in a format such as pulse code modulation, for example.

At step 410, an equalization based on the source identified can be applied in view of the identifier packet. Referring to FIG. 2, the equalizer 214, can receive an audio signal from the audio module 212. The equalizer 214 can apply an equalization to the audio signal when the monitoring unit 210 identifies a source of the discontinuous transmission activity. The monitoring unit 212 can identify an invalid frame type (identifier packet) and thereby recognize that the data did not go through a tandem vocoding operation at transcoders 203 and 204 in the base receiver 102. The monitoring unit 212 can identify the source of the discontinuous activity as the transmitting unit 102. Accordingly, the monitoring unit can acknowledge that the audio signal did not incur any intermediate equalization at the base receiver 201 or 207. And, the monitoring unit 212 can elect to not equalize the audio signal at the equalizer 214. Alternatively, when the monitoring unit 212 does not receive an identifier packet (invalid frame), it can identify the source of the discontinuous transmission activity as the base receiver 201. Recall, the base receiver 201 may replace empty slots with null slots and continually transmit every frame. Accordingly, the base receiver 201 does not practice discontinuous transmission activity but can be a source of modifying discontinuous transmission activity. The equalizer 214 can apply an equalization to compensate for an audio equalization applied at the source. The equalizer 214 can store a reference audio equalization for each type of identifier packet. Based on the identifier packet received, the equalizer 214 can apply the corresponding equalization. The invalid frame was selected as the identifier packet for an AMBE vocoder in the first transcoder 203 because it has interpretation properties specific to the AMBE vocoder during DTX. It should be noted that different vocoders each have their own frame type decoding rules. The various frame types each illicit characteristic decoding behaviors during DTX, and the corresponding frame type can serve as distinct identifier packet for identifying the source and performing the audio equalization.

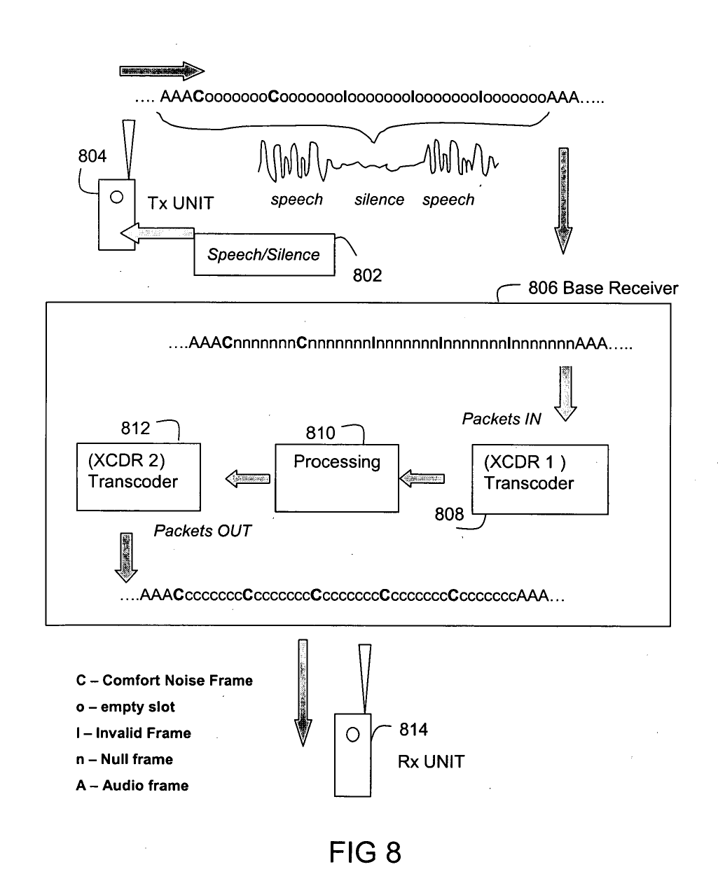

Referring to FIG. 8, an illustration of the frame type conversions as the data packets are transmitted through the base receiver 201 between the transmitting unit 102 and the receiving unit 106 is shown. The illustration of FIG. 8 serves to show the details of the method 400. At step 802, voice consisting of speech and silence regions can be spoken into the phone at the transmitting unit 102 which can convert the voice to data packets. During silence, the transmitting unit 102 can send CNU frames (C) every 8^{th} empty slot (o), for instance. An empty slot can signify no transmission during that interval. During transmission at the transmitting unit 102, Invalid frames (I) with random bits can be inter-dispersed during DTX to increase the bit level packet variability as a means to keep up the Signal Strength Indicator (SSI) and preserve the Signal Quality Estimation (SQE) (data packet types are listed in the legend).

At step 804, packets of data representing DTX data for a typical section of silence during speech can be transmitted. During transmission, the marking unit 202 of FIG. 2 can inter-disperse the invalid frames (I) with random bits to serve as the identifier packet during DTX. At step 806, the base receiver 201 can read the invalid frame type from the received data stream and utilize the random data to identify signal quality estimate channel activity. The base receiver 201 can insert null frames (n) for each empty slot (o) identified, i.e. it can replace empty slot intervals with null frames. The base receiver 201 can then forward the data packets to the transcoder 203.

At 808 the first transcoder 203 (XCDR1) can convert audio frames (A) to speech and CNU frames (C) and null frames (n) to comfort noise to produce an audio signal. The produced comfort noise within the audio signal can represent the silence regions of speech. When 3 or more consecutive invalid frames are received, the first transcoder 203 can decode them into silence frames. When less than 3 invalid frames are received, the transcoder 203 can issue a frame repeat which during DTX can produce comfort noise frames. Since invalid frames are inter-dispersed with CNU frames, the transcoder 203 (XCDR1) can generate silence for the invalid frames.

At step 810, intermediate processing such as audio equalization can occur during the tandem operation between the first transcoder 203 (XCDR1) and the second transcoder 204 (XCDR2) after the data is converted to an audio signal. For example, the base receiver 201 can apply various types of equalization during a tandem operation where the equalization can be applied to account for high frequency capacitance losses during transmission. At step 810, the first transcoder 203 can convert invalid frame types to silence which can be re-encoded to comfort noise frame types by the second transcoder 204. The tandem decoding and encoding by transcoders 203 and 204 can remove the invalid frame thereby modifying the identifier packet. The identifier packet will not be received by the receiver unit 106.

At step 812, the second transcoder 204 encodes the speech and silence into a vocoder data format acceptable to the receiver unit 106. The second transcoder 204 can transmit every frame without empty slots because it is not power limited. Frame transmissions from the second transcoder 204 to the receiving unit 106 can be continuous since the second transcoder 204 does not employ DTX. The second transcoder 204 converts silence to CNU frames and does not insert invalid frames. At step 814, the receiving unit 106 can receive audio (A) and comfort noise frames (CNU) without inter-dispersed invalid (I) frames. The receiving unit 106 decodes received audio and comfort noise data packets and converts them to speech and silence, respectively.

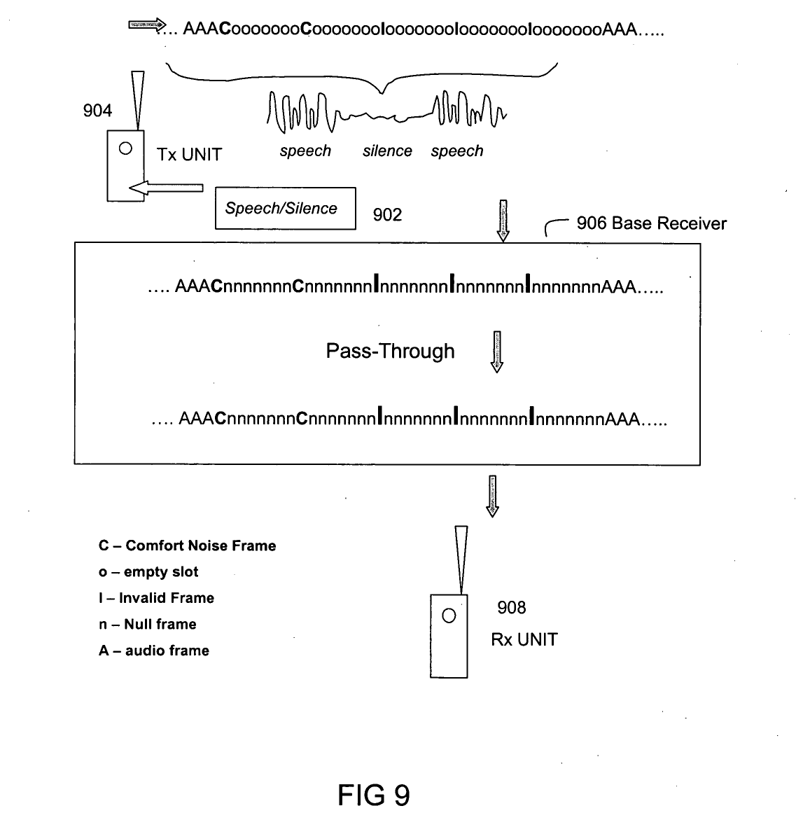

It is also possible that the base receiver operates in pass-through mode. For example, referring to FIG. 9, at 902, the transmitting unit 102 can send CNU frames (C) every 8^{th} empty slot (o). During transmission, invalid frames with random bits can be inter-dispersed during DTX at the transmitting unit 102 to increase signal quality estimation. At step 906, the base receiver 201 can insert null frames (n) for each empty slot (o) within the data received. The base receiver 201 will not pass the data to the transcoders 203 and 204 which will not modify the invalid frames. At step 908, the receiving unit 106 can received the preserved invalid frames (identifier packet) and can decode them accordingly. The data packets with the invalid frame types are preserved when the base receiver 201 operates in pass-through mode.

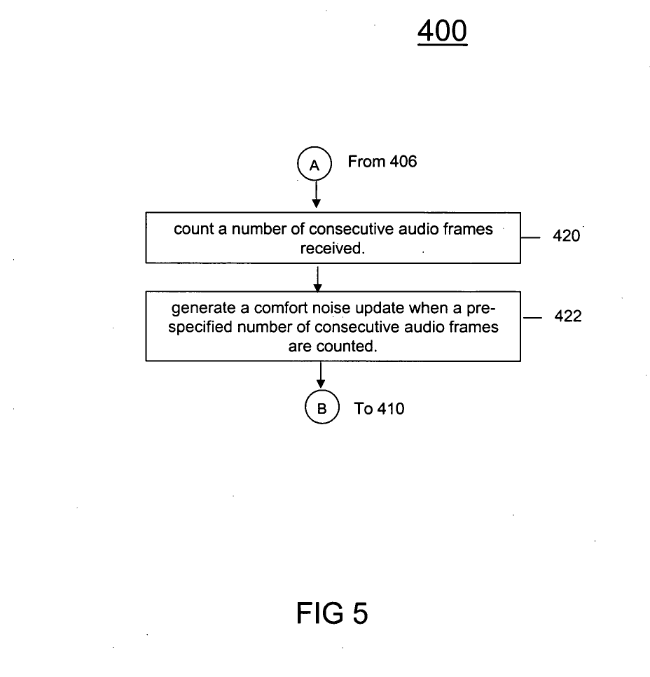

Referring to FIG. 5, a method 500 that incorporates the steps of the method 400 is shown. The method 500 can enable and disable comfort noise generation over a communication channel. In describing the method 500, reference will be made to FIGS. 2, 3, 4, 6 and 7, although it must be noted that the method 500 can be practiced in any other suitable system or device. Moreover, the steps of the method 500 are not limited to the particular order in which they are presented in FIG. 5. The inventive method can also have a greater number of steps or a fewer number of steps shown in FIG. 5, which can include or eliminate all the steps of the method 400 of FIG. 4, if so desired.

With reference to FIG. 4, the steps can occur between method steps 406 and 410. At step 420, a number of consecutive audio frames received can be counted. At step 422, a comfort noise update can be generated when a pre-specified number of consecutive audio frames are counted.

For example, referring to FIG. 2, the transmitting unit 102 can enter DTX to generate comfort noise data when it determines minimal voice activity. The receiving unit 106 can receive the comfort noise data and update the comfort noise at the audio module 212 with respect to the last audio frame received. The last audio frame received can serve as the differential reference for forthcoming comfort noise frames and accordingly comfort noise generation. If a last audio frame is received in error, or the last audio frame received is corrupt, future comfort noise frames can fail to produce accurate background comfort noise, since those frames are differentially encoded from the last received audio frame.

Referring to FIG. 3, the logic unit 216 can count a consecutive number of audio frames to monitor spurious audio frames received by the monitoring unit 210. The controller 218 can accordingly enable or disable comfort noise generation based on a threshold number of consecutive audio frames counted by the logic unit 216. The controller 218 can disable comfort noise generation when a pre-specified number of consecutive audio frames represents a voice utterance length shorter than the minimal voice length a human can vocalize. The controller 218 can enable comfort noise generation when the pre-specified number of consecutive audio frames is of a length at least representative of a voice utterance length a human can vocalize.

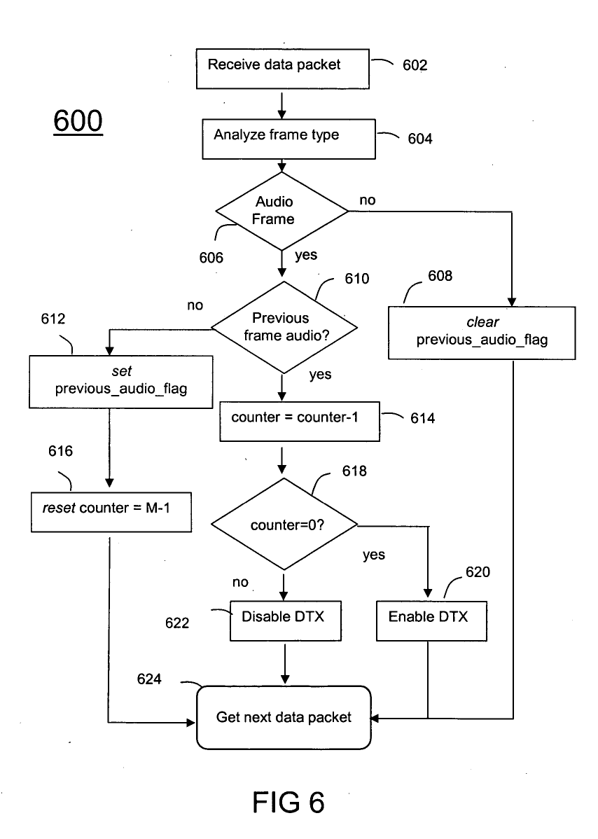

For example, referring to FIG. 6, a flowchart illustrating the method 600 for determining a minimal voice activity length to enable or disable comfort noise update is shown. The method 600 can be applied to every frame received at the receiving unit 106. The method 600 uses historical information in a counter variable and a separate previous_audio_flag indicator variable. At step 602, the receiving unit 106 can receive a data packet. At step 604, the monitoring unit 210 can analyze the frame type. At step 608, the monitoring unit 210 can determine if the received frame type was an audio frame. If it is not an audio frame, the logic unit 216 can clear the previous_audio_flag to signify for the next received frame check that the previous frame was not an audio frame. The previous_audio_flag is a flag with one state memory. If it is an audio frame, the logic unit 216 can check to see if the previous frame received was an audio frame by checking the status of the previous_audio_flag indicator. If the previous frame was an audio frame, the logic unit 216 decrements the counter at step 614. At step 618, the logic unit 216 checks to see if the counter has decremented to zero. A counter decremented to zero can indicate the presence of voice activity given that a minimal number of consecutive audio frames has been detected and thus DTX can be enabled at step 620 before getting the next data packet at step 624. At step 622, if the counter is not equal to zero, the controller 218 disables DTX given the presumption from the logic unit 216 that the audio frames are too short to represent speech and may represent an audio glitch before obtaining the next packet at step 624. At step 624, if the counter is zero at decision step 618, then a sufficient number of consecutive audio frames has been received for the controller 218 to enable DTX. At step 610, if the monitoring unit 210 determines the previous frame was not audio, the logic unit 216 can set the previous_audio_flag to indicate a non-consecutive occurrence of audio frames at 612. At step 616, the logic unit 216 can reset the counter to a number corresponding to a pre-specified number of consecutive audio frames required for detection before voice activity is determined present.

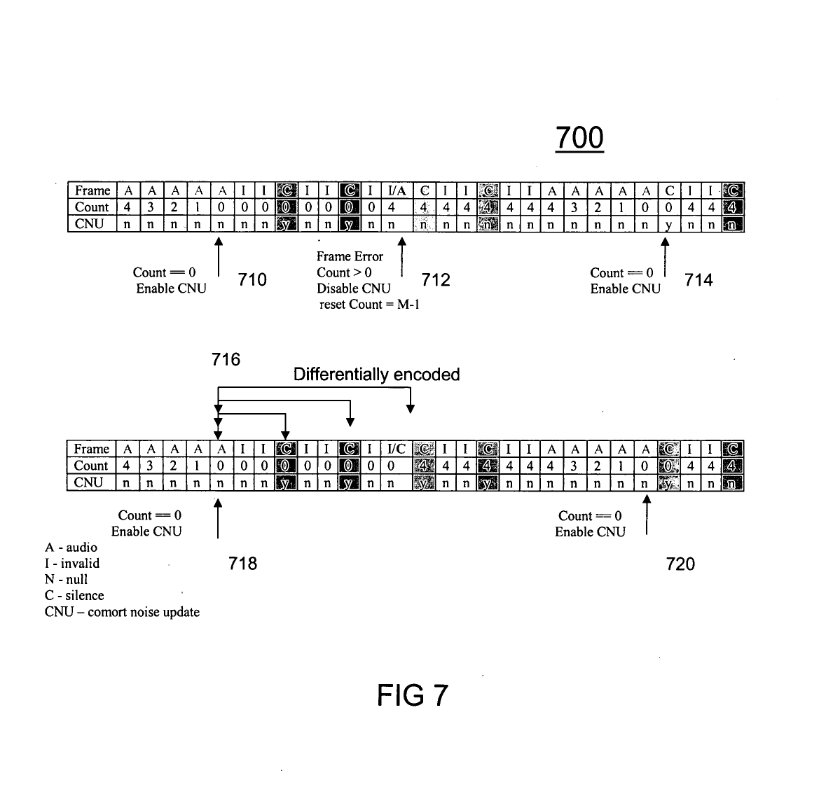

For example, referring to FIG. 7, a pictorial of the frame types during DTX at the receiving unit 106 is shown. For example, referring to FIG. 3, the monitoring unit 210 receives frames in the data slots and interprets the frame types as audio, invalid, null, or silence as illustrated in FIG. 7. The logic unit 216, counts the number of audio frames received and keeps track of the consecutive number of audio frames received as illustrated by the method 600 of FIG. 6. For example, at location 710, the count has decremented from 4 to 0 indicating the occurrence of 5 consecutive audio frames which can be the pre-specified threshold to control comfort noise update for this example. The controller 218, enables comfort noise update based on the counter reaching 0. At location 712, an invalid frame has been incorrectly received as an audio frame. Correspondingly, the logic unit 216 in the method 600 of FIG. 6 sets the previous audio flag at step 612 and resets the counter at step 616. The controller 218 can disable comfort noise update until 4 more audio frames are received consecutively, which is currently not the case at location 712. Accordingly, the audio frame at location 712 was received in isolation, and the controller 218 disables DTX given the counter value not equal to zero in the logic unit 216. At location 714, the logic unit 216 counts 5 consecutive audio frames received, decrements the counter to zero, and the controller 218 enables comfort noise update. For example, the minimal voice length a human can vocalize is approximately 5 frames.

It is necessary to disable comfort noise update when a spurious audio frame is received because comfort noise generation is based on the last good audio frame received. For example, at location 718, the audio frame serves as the referential basis for the 3 proceeding comfort noise frames (silence frames) which are differentially encoded from the audio frame at 716. If the audio frame was erroneous, each of the comfort noise frames received would produce silence not representative of the background noise conditions at the transmitter 102. The logic unit 216 and controller 218 serve to prevent isolated audio frames from being used as the referential basis frame. At location 720, the logic unit 216 has counted a proper number of consecutive audio frames and accordingly decrements the count down to zero. This implies that true voice activity has been identified and any proceeding comfort noise frames can be properly decoded.

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiments of the invention is not so limited. Numerous modifications, changes, variations, substitutions and equivalents will occur to those skilled in the art without departing from the spirit and scope of the present embodiments of the invention as defined by the appended claims.

What is claimed is:

1. A method for monitoring a data channel for discontinuous transmission activity comprising the steps of:
identifying a source of modification of the discontinuous transmission activity based on receipt of an identifier packet; and
applying an equalization based on the source identified in view of the identifier packet.

2. The method of claim 1, wherein the method further comprises the step of modifying the identifier packet during discontinuous transmission activity over a communication channel.

3. The method of claim 1, wherein the method further comprises the step of preserving the identifier packet over the communication channel.

4. The method of claim 1, wherein the source of the discontinuous transmission activity is a mobile communication device or a transcoder.

5. The method of claim 1, wherein the method further comprises the steps of:
generating an audio signal from data received on the data channel; and
applying the equalization to the audio signal in view of the identifier packet.

6. The method of claim 1, wherein the method further comprises the steps of:
marking an identifier packet within a first communication device during discontinuous transmission activity; and
transmitting the identifier packet over a communication channel to a second communication device.

7. The method of claim 1, wherein the method further comprises modifying the identifier packet over a communication channel during discontinuous transmission activity, wherein the modification associates the identifier packet with the source.

8. The method according to claim 5, wherein the equalization further comprises compensating for an audio equalization applied at the source.

9. The method according to claim 5, further comprising:
counting a number of consecutive audio frames received; and
generating a comfort noise update when a pre-specified number of consecutive audio frames are counted.

10. The method according to claim 9, wherein the pre-specified number is at least a minimum number of audio frames representative of a voice utterance.

11. A system for monitoring a data channel for discontinuous transmission activity, comprising:
a monitoring unit, wherein the monitoring unit identifies a source of the discontinuous transmission activity based on receipt of an identifier packet; and
an equalizer coupled to the monitoring unit, wherein when the monitoring unit determines that an identifier packet has been modified by a source over a communication channel, the equalizer applies a compensatory equalization associated with the identified source to compensate for equalization applied at the source.

12. The system of claim 11, further comprising a processor communicatively coupled to the monitoring unit to modify the identifier packet over a communication channel during discontinuous transmission activity, the identifier packet modified prior to being received by the monitoring unit, wherein the modification associates the identifier packet with the source.

13. The system of claim 11, further comprising a marker unit communicatively coupled to the monitoring unit to create an identifier packet in a first communication device, the identifier packet to be modified within a communication network during discontinuous transmission activity, the identifier packet to be received by a second communication device, wherein the second communication device includes the monitoring unit and the equalizer.

14. The system of claim 12 wherein the identifier packet is modified to be one of an audio frame type, a silence frame type, a null frame type, or an invalid frame type.

15. The system of claim 12 wherein the processor resides within a mobile communication device or a base receiver for modifying the identifier packet.

16. The system of claim 11, wherein the monitoring unit further comprises an audio module connected to the equalizer to receive data from the data channel and generate an audio signal from the data received, wherein the equalizer applies compensatory equalization to the audio signal in view of the identifier packet to compensate for equalization applied to the audio signal at the source.

17. The system of claim 11, further comprising:
a logic unit coupled to the monitoring unit to count a number of consecutive audio frames received from the data channel; and
a controller connected to the logic unit to update comfort noise generated by an audio module when a pre-specified number of consecutive audio frames are counted by the logic unit;
wherein the comfort noise is differentially encoded from the last audio frame received.

18. The system of claim 17 wherein the controller disables comfort noise generation when the pre-specified number of consecutive audio frames represents a voice utterance length shorter than the minimal voice length a human can vocalize.

19. The system of claim 17 wherein the controller enables comfort noise generation when the pre-specified number of consecutive audio frames is of a length at least representative of a voice utterance length a human can vocalize.

20. A system for monitoring a data channel for discontinuous transmission activity based on receipt of an identifier packet, comprising:
a marker unit to mark an identifier packet within a data stream during discontinuous transmission activity, the identifier packet to be transmitted from a first communication device to a second communication device over a communication channel;
a monitoring unit communicatively coupled to the marker unit to identify a source that modified the identifier packet over the communication channel during discontinuous transmission activity;
an audio module cooperatively connected to the monitoring unit to generate an audio signal from the data stream received over the communication channel; and
an equalizer coupled to the monitoring unit, wherein when the equalizer applies a compensatory equalization to the audio signal to account for equalization applied at the source.
